(19) United States
(12) Patent Application Publication
(10) Pub. No.: US 2017/0225350 A1
(43) Pub. Date: Aug. 10, 2017

(54) TOOL FOR PERFORATING AND INSERTING BYPASS ACCESSORIES IN WATER PIPES

(71) Applicant: JESUS ANGEL LOPEZ RAMIREZ, LA MANGA DEL MAR MENOR (Murcia) (ES)

(72) Inventor: JESUS ANGEL LOPEZ RAMIREZ, LA MANGA DEL MAR MENOR (Murcia) (ES)

(21) Appl. No.: 15/017,719

(22) Filed: Feb. 8, 2016

(51) Int. Cl. B26F 1/00

(52) U.S. Cl. CPC B26F 1/003; B26F 1/0053

(57) ABSTRACT

oval polyethylene pipes (3), which consists of: a primary constriction mechanism (2), consisting of two symmetrical rotating bars (21), with lower bypass sections (22) that may be opened or closed in order to apply pressure to the pipe (3); and a secondary mechanism (4) that perforates the pipe (3) and inserts the specific bypass accessory (5) through a central bar (41) that can be moved vertically and longitudinally, incorporating a tubular connection piece (43) where a punch (8) and bypass accessory (5) are inserted.

### OBJECT OF THE INVENTION

As described in this report, the invention is a tool for perforating and inserting bypass accessories in water pipes, which offers specific advantages and features that would significantly improve upon the current techniques used for the purposes of this tool, which are described below in detail.

The specific purpose of this invention is to serve as a tool that facilitates water pipe perforating operations, particularly for polyethylene oval pipes, as well as the insertion of accessories for connecting secondary bypass pipes, permitting both operations to be quickly and safely executed simultaneously without running the risk of damaging the other side of the pipe being perforated.

### APPLICATION FIELD OF THE INVENTION

The area of application for this invention is framed within the manufacturing industry for equipment, devices, machinery, and tools for water facilities, particularly those involved in perforating pipes and inserting accessories into the perforations.

### BACKGROUND OF THE INVENTION

At the present time, operations for perforating water pipes and inserting accessories for bypass pipes connections are executed by first using a manual punch tool and then inserting the accessory through the perforation, which is also done manually by applying pressure with the palm of your hand.

The invention is intended for use with polyethylene pipes, which are usually oval-shaped when empty so that they can be rolled up for transportation and storage, thereby reducing the space they occupy as compared to pipes with rigid circular cross-sections, since pipes may start at a minimum of 2″ in diameter and go upwards from there, and a single roll can be anywhere from 200 to 300 meters long.

It is important to note that in order to avoid potential water leaks in the bypass connection points, it is preferable for these bypasses to be installed in the top flat part of the pipe; however, when perforating this area, you run the risk of damaging the internal surface of the opposite side of the pipe with the point of the punch tool, since due to its oval shape, the top and bottom parts of the pipe are closer together than the lateral sides.

The purpose of this invention is therefore to provide a tool that allows you to perforate this type of pipe and insert bypass accessories in a safer, more practical way in one single operation, thereby reducing the time required for these operations and avoiding the risk of damaging the internal surface of the opposite side of the pipe.

Regarding the current techniques used for these purposes, it is important to note that the applicant is unaware of the existence of any other tool or invention with similar applications that have similar technical, structural or constituent characteristics to those presented herein, as claimed for the purposes of this patent.

### EXPLANATION OF THE INVENTION

The proposed tool for perforating and inserting bypass accessories in water pipes has been conceived as a significant innovation within its area of application since, based on its implementation, it fully meets the aforementioned objectives. The details of the distinguishing characteristics that make this invention possible are conveniently included in the final claims at the end of this report.

As previously mentioned, the invention is a tool specifically designed to facilitate water pipe perforating operations, particularly for oval polyethylene pipes, and the insertion of accessories for connecting secondary bypass pipes in the resulting perforations in one single operation.

The tool has a primary mechanism that constricts the pipe, holding it in place and bending it in order to reshape the normally oval cross-section, where the horizontal diameter is greater than the vertical diameter. Consequently, the new shape is optimal for perforating the top part of the pipe, since the resulting horizontal diameter is now less than the vertical diameter, thereby increasing the distance between the top and bottom sides of the pipe.

This first mechanism preferably consists of two manually operated parallel rotating bars, the lower ends of which have modified sections in order for the bypass to be symmetrical. Depending on their position, they may be more or less separated so that, in the open position, where said sections are further apart from the lower ends, they are attached to both sides of the oval pipe in its initial resting position, and when rotated to the closed position, using handles on the top ends of the bars, they move closer together, applying pressure to the sides of the pipe and reshaping it as previously explained.

The tool also has a secondary mechanism that provides means for perforating the top part of the pipe, once it has been reshaped, while simultaneously inserting the accessory for the bypass pipe connection.

The preferred execution of said mechanism, which is also preferably manual, consists of a third central bar, which, connected to the other two bars for the primary mechanism through a guide for each bar, incorporates a punch on the lower end for perforating and a thread for the accessory, which has a T lever on the top end. This allows you to apply pressure with the bar by exercising force on the pipe, which proceeds to perforate and insert the accessory.

The tool for perforating and inserting bypass accessories in water pipes described herein therefore offers innovative structural and constituent features that were previously unknown until now, which, along with its practical utility, constitute adequate grounds for obtaining the requested privilege of exclusivity.

### DESCRIPTION OF DRAWINGS

In order to provide a better understanding of the invention's features, in addition to its description, a series of drawings have been included as an integral part of this descriptive report, which include, but are not limited to, the following:

FIG. No. 1—Schematic elevation view of an example of using the invented tool, depicted in its initial position over the oval pipe to be perforated, showing the configuration of said pipe as well as the tool's parts and elements, in addition to its configuration and layout.

FIG. No. 2—Elevation view, similar to the previous figure, of the same example of the invented tool, here depicted in the constriction phase for reshaping the pipe.

FIG. No. 3—Elevation view of the example of the invented tool shown in the previous figures, here depicted in the pipe perforation phase.

FIG. No. 4—Perspective view of the bottom part of the tool, depicted without incorporating the bypass accessory, showing the configuration of the threaded punch and the screw for regulating and ensuring the position of said accessory.

### PREFERRED EXECUTION OF THE INVENTION

Considering the abovementioned figures according to their corresponding numeration, you can observe an illustrative example of the tool for perforating and inserting bypass accessories in water pipes consisting of the aforementioned parts and elements, which are described in detail below.

These figures show that the tool (1) in question consists of, essentially, a primary mechanism (2) that constricts the oval pipe (3) and holds the pipe (3) in place while bending it so that the horizontal diameter (3a) is less than the vertical diameter (3b), and a secondary mechanism (4) that perforates the pipe (3) and inserts the bypass accessory (5).

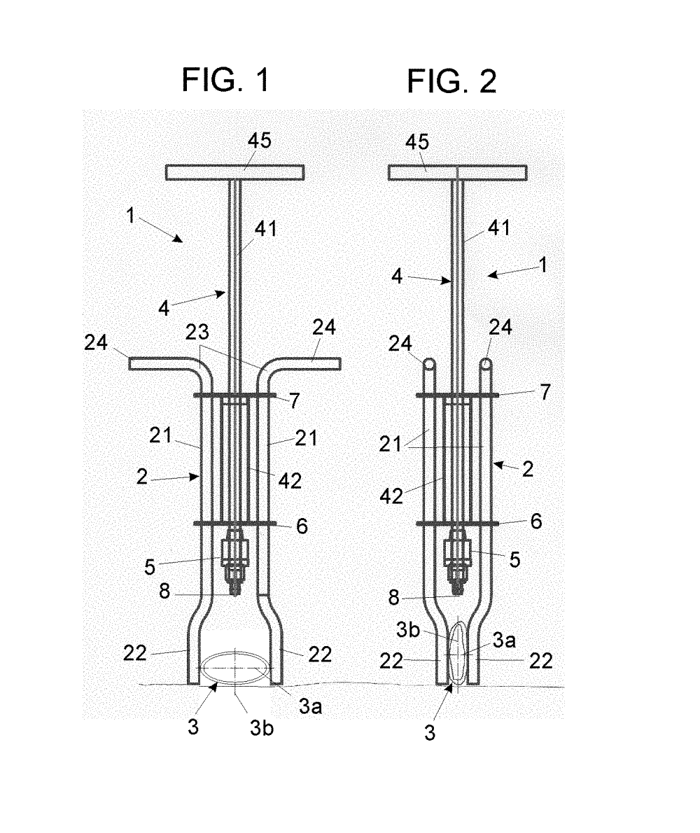

FIGS. 1 and 2 show said modification of the oval pipe (3) from its initial configuration (FIG. 1) where the horizontal diameter (3a) is larger than the vertical diameter (3b), to its resulting configuration after pressure is applied with the tool's (1) primary mechanism (2), where the horizontal diameter (3a) is less than the vertical diameter (3b), thereby increasing the distance between the top and bottom sides of the pipe (3) in order to perforate safely.

The first constriction mechanism (2) preferably consists of two manually operated symmetrical rotating bars (21), which have an identical configuration and are connected to both supports, one on top (6) and one below (7), which hold them symmetrically in place, keeping them parallel while permitting their rotation.

The lower ends of the rotating bars (21) have respective bypass sections (22) corresponding to their longitudinal diameter, which, depending on the rotating position of each rotating bar (21), are either open or closed, or more or less separated so that in the open position, they are attached to both sides of the oval pipe (3) in its initial resting position (FIG. 1), and when rotated to the closed position (FIG. 2), they apply pressure to the sides of the pipe (3), thereby reshaping it and modifying the distance between the top and bottom sides, as previously explained.

The ends of these bypass sections (22) for both rotating bars (21) preferably have slip-resistant stops (25).

In order to turn the rotating bars (21), the top ends of these bars each have a bend (23), which forms a rotating handle (24) on each bar.

The secondary mechanism (4), which is also manually operated, consists of a third central bar (41), which is attached to the supports (6, 7) that hold the rotating bars (21) in place through a guide (42), and can slide between them with a vertical longitudinal movement.

As shown in FIG. 4, this central bar (41) also has a tubular connection piece (43) on the lower end where the punch (8) is inserted, which is apt for perforating the pipe and inserting a bypass accessory (5).

For said insertion, the aforementioned punch (8) should have a threaded part (8a) to fasten it to the tubular connection (43), which also permits the incorporation of a screw (44) used to fasten the accessory (5) in order to adapt the size, since it may vary.

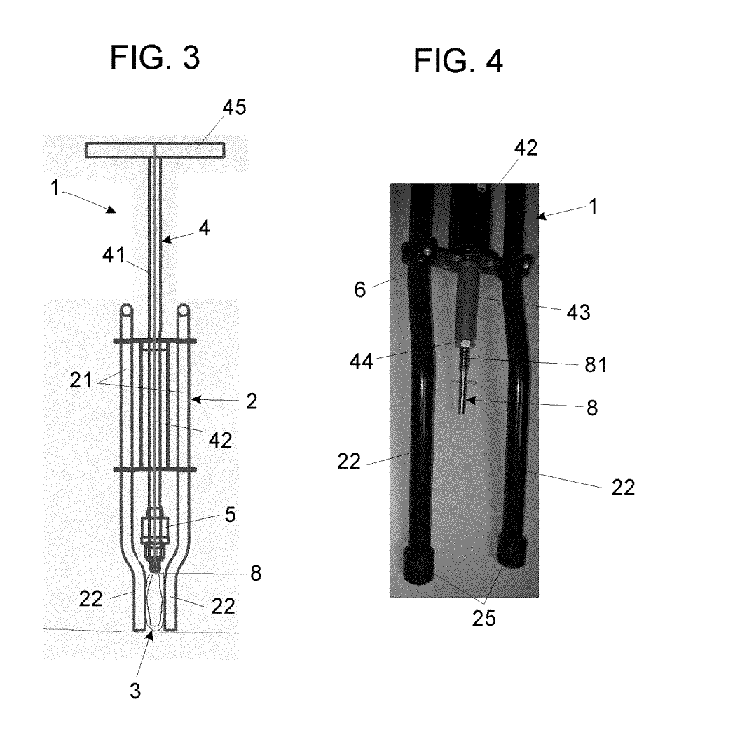

Finally, in order to use this perforation and insertion mechanism (4), the top end of the central bar (41) has a T lever (45) that is used to apply pressure by exercising force to move the bar and drive the punch (8) into the top part of the pipe (3), as shown in FIG. 3, simultaneously inserting the accessory (5) in the resulting perforation.

Having adequately described the nature of this invention and how to use it, we therefore consider a more extensive explanation unnecessary for an expert in this field to understand the scope and consequent advantages of the invention, although it is true that the abovementioned operations could essentially be performed using other execution methods that differ from the indicated example, which would also provide the same desired level of protection as long as the fundamental principles are not altered, changed or modified.

1. TOOL FOR PERFORATING AND INSERTING BYPASS ACCESSORIES IN WATER PIPES, particularly for oval polyethylene pipes (3), comprising a primary mechanism (2) to constrict the oval pipe (3) that holds it in place and bends said pipe (3) so that the resulting horizontal diameter (3a) is less than the vertical diameter (3b), and a secondary mechanism (4) that perforates the pipe (3) and inserts the bypass accessory (5).

2. TOOL FOR PERFORATING AND INSERTING BYPASS ACCESSORIES IN WATER PIPES, comprising a primary constriction mechanism (2) as consisting of two rotating bars (21), of identical configuration and symmetrical layout, whose lowers ends have respective bypass sections (22) corresponding to its longitudinal access. Depending on the rotation position of the rotating bars (21), whether open or closed, or more or less separated, in the open position they are attached to both lateral sides of the oval pipe (3) in its initial resting position, and in the closed position, they apply pressure to the sides of the pipe (3), bending it and modifying the distance between the top and bottom sides.

3. TOOL FOR PERFORATING AND INSERTING BYPASS ACCESSORIES IN WATER PIPES, according to claim 2, comprising rotating bars (21) being attached to both supports, one on top (6) and one below (7), which hold them in place and keep them parallel while permitting their rotation.

4. TOOL FOR PERFORATING AND INSERTING BYPASS ACCESSORIES IN WATER PIPES, according to claim 2, comprising rotating bars (21) that are manually operated.

5. TOOL FOR PERFORATING AND INSERTING BYPASS ACCESSORIES IN WATER PIPES, according to claim 2, comprising the top end of the rotating bars (21) having rotating handles (24).

6. TOOL FOR PERFORATING AND INSERTING BYPASS ACCESSORIES IN WATER PIPES, according to claim 1, comprising a secondary mechanism being formed by a central bar (41) that can be moved vertically and longitudinally, incorporating a tubular connection piece on the lower end (43) where a punch (8) is inserted, which is apt for perforating the pipe and inserting a bypass accessory (5).

7. TOOL FOR PERFORATING AND INSERTING BYPASS ACCESSORIES IN WATER PIPES, according to claim 1, comprising a punch (8) having a threaded part (8a), which, in addition to its attachment to the tubular connection (43), incorporates a screw (44) used to fasten the accessory (5) in order to adapt to different possible sizes.

8. TOOL FOR PERFORATING AND INSERTING BYPASS ACCESSORIES IN WATER PIPES, according to claim 1, comprising the top end of the central bar (41) having a manually operated T lever (45) for applying pressure.

9. TOOL FOR PERFORATING AND INSERTING BYPASS ACCESSORIES IN WATER PIPES, according to claim 1, comprising the central bar (41) being attached to the supports (6, 7) that hold the rotating bars in place (21) through a guide (42) for each bar.
